(19) United States
(12) Patent Application Publication
(10) Pub. No.: US 2011/0202954 A1
(43) Pub. Date: Aug. 18, 2011

(54) ELECTRONIC DEVICE

(75) Inventors: Hiroyuki OKA, Hino-shi (JP); Akane NAKAMURA, Oume-shi (JP)

(73) Assignee: KABUSHIKI KAISHA TOSHIBA, Tokyo (JP)

(21) Appl. No.: 13/028,105

(22) Filed: Feb. 15, 2011

(30) Foreign Application Priority Data
Feb. 15, 2010 (JP) 2010-030552

(51) Int. Cl. H04N 5/445

(52) U.S. Cl. 725/37

(57) ABSTRACT

According to one embodiment, an electronic device includes an input module and a video output module. The input module is configured to receive video contents data including motion picture data. The video output module is configured to output the motion picture data to a first display device and to output image data of a first screen for command entry for the video contents data to a second display device when video contents are displayable at the first and the second display devices. The video output module is configured to output image data of a second screen for displaying the motion pictures and an image for the command entry to one of the first and second display devices at which the video contents are displayable.

### CROSS REFERENCE TO RELATED APPLICATION(S)

This application is based upon and claims the benefit of priority from Japanese Patent Application No. 2010-030552 filed on Feb. 15, 2010, the entire contents of which are incorporated herein by reference.

### BACKGROUND

1. Field

Embodiments described herein relate generally to an electronic device.

2. Description of the Related Art

There is a technique which receives video contents data along with data-broadcasting data and displays a menu screen image for entering commands on the video contents data, an image based on the data-broadcasting data, etc. on a screen together with the video based on the video contents data. It is desirable that the video can be displayed in a wide range without any hiding portion in order for a user to confirm the contents of the displayed video. However, sometimes the video may be hidden behind another image or the display region of the video may be narrowed if the video and the other image are displayed on the same screen.

Incidentally, it is desirable that an electronic device capable of outputting video data to a plurality of display devices can output the video data, data of a menu screen image, etc. in suitable formats corresponding to the number of the display devices.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary view showing an available form of an electronic device according to a first embodiment;

FIG. 2 is an exemplary view showing an example of system configuration of the electronic device according to the first embodiment;

FIGS. 3A and 3B are exemplary views showing a screen which the electronic device according to the first embodiment outputs to one display device;

FIGS. 4A and 4B are exemplary views showing screens which the electronic device according to the first embodiment outputs to two display devices;

FIG. 5 is an exemplary view showing a setting screen which the electronic device according to the first embodiment outputs;

FIG. 6 is an exemplary flow chart showing procedures of the electronic device according to the first embodiment;

FIGS. 7A and 7B are exemplary views showing screens which the electronic device according to the first embodiment outputs to two display devices;

FIGS. 8A and 8B are exemplary views showing a screen which the electronic device according to the first embodiment outputs to two display devices; and

FIG. 9 is an exemplary view showing an available form of an electronic device according to a second embodiment.

### DETAILED DESCRIPTION

In general, according to one embodiment, an electronic device comprises an input module and a video output module. The input module is configured to receive video contents data comprising motion picture data. The video output module is configured to output the motion picture data to a first display device and to output image data of a first screen for command entry for the video contents data to a second display device when video contents are displayable at the first and the second display devices. The video output module is configured to output image data of a second screen for displaying the motion pictures and an image for the command entry to one of the first and second display devices at which the video contents are displayable.

### First Embodiment

A first embodiment will be described below with reference to the drawings.

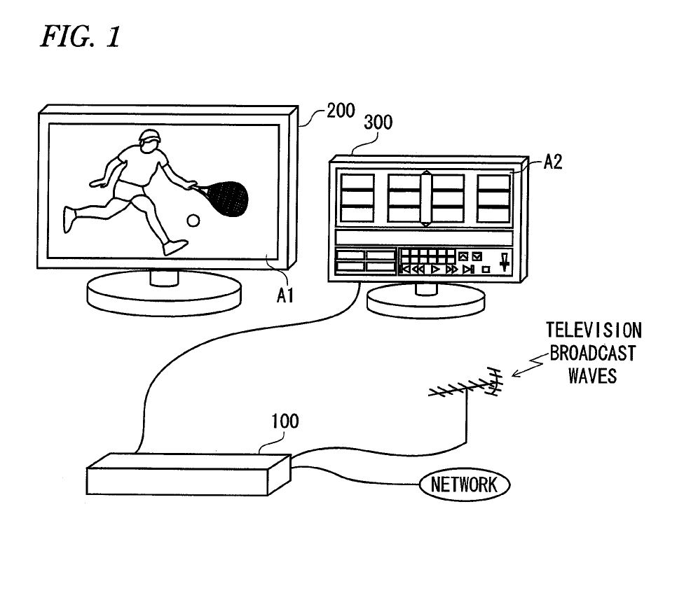

FIG. 1 is an exemplary view showing an available form of an electronic device according to this embodiment. For example, the electronic device according to this embodiment is put into practice as a receiver 100. The receiver 100 can receive video contents data comprising video data and data-broadcasting data such as digital broadcast contents, IPTV contents, etc., and display a screen based on the video contents data on display devices 200 and 300.

For example, the screen based on the video contents data is a screen of motion pictures based on video data, a screen of operation images based on data-broadcasting data, etc. Incidentally, the operation images are images for allowing a use to enter commands on video contents data.

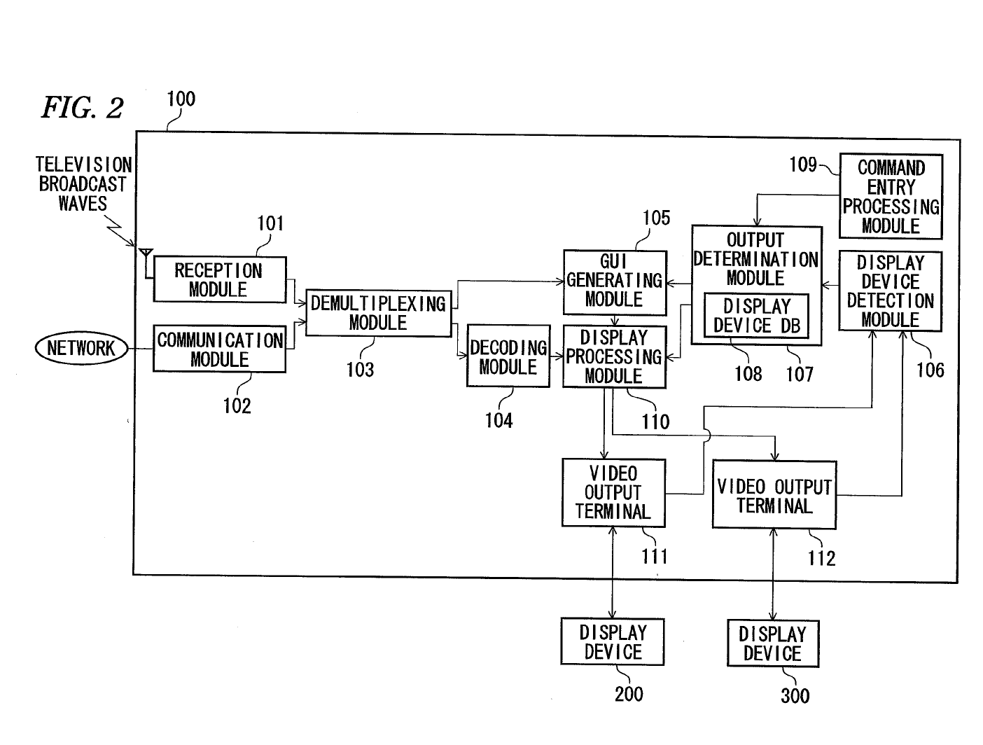

When two display devices are connected to the receiver 100, the receiver 100 can output a screen comprising motion pictures as represented by A1 to one display device and output a screen of operation images as represented by A2 to the other display device. On the other hand, when one display device is connected to the receiver 100, the receiver 100 can output a screen comprising motion pictures based on video data and operation images. Details will be described below with reference to FIGS. 2, 3A-3B, 4A-4B, 5-6, 7A-7B and 8A-8B.

The system configuration of the receiver 100 will be described below with reference to FIG. 2. FIG. 2 is an exemplary view showing an example of system configuration of the receiver 100.

The receiver 100 has a reception module 101, a communication module 102, a demultiplexing module 103, a decoding module 104, a GUI generating module 105, a display device detection module 106, an output determination module 107, a command entry processing module 109, a display processing module 110, a video output terminal 111, a video output terminal 112, etc.

The reception module 101 is connected to a TV antenna and receives digital broadcast waves. On this occasion, the reception module 101 can receive video contents data comprising motion picture data and data-broadcasting data and output the received video contents data to the demultiplexing module 103.

The communication module 102 is connected to a network outside the receiver 100 and receives video contents data comprising motion picture data and data-broadcasting data from an IPTV server etc. (not shown). Then, the communication module 102 outputs the received video contents data to the demultiplexing module 103.

Incidentally, motion picture data comprised in the video contents data received by the reception module 101 and the communication module 102 are data of motion pictures to be played back on the display device. Data-broadcasting data are described in a language such as BML and comprises GUI data of a screen outputted to the display device, such as, image data arranged on a screen, and information of a position where the image is arranged.

The data-broadcasting data further comprises information about the title of a program of motion pictures currently played back and displayed in a motion picture display region (which will be described later), contents of the program, etc., and a link indicating contents related to the motion pictures and an Internet URL. Incidentally, the GUI data comprised in the data-broadcasting data are data concerned with a GUI of a screen when the receiver 100 outputs the screen to a single display device. When the receiver 100 outputs a screen to display devices, the receiver 100 generates a GUI based on the GUI data.

The demultiplexing module 103 demultiplexes the video contents data inputted from the reception module 101 and the communication module 102 into motion picture data and data-broadcasting data. Then, the demultiplexing module 103 outputs the demultiplexed motion picture data to the decoding module 104 and outputs the demultiplexed data-broadcasting data to the GUI generating module 105.

The decoding module 104 decodes the motion picture data inputted from the demultiplexing module 103. Then, the decoding module 104 outputs the decoded motion picture data to the display processing module 110.

The GUI generating module 105 generates a screen of operation images to be outputted to the display device, based on the data-broadcasting data inputted from the demultiplexing module 103. On this occasion, the GUI generating module 105 generates a screen based on an output destination instruction and a notification about a screen size and a resolution inputted from the output determination module 107.

That is, when the GUI generating module 105 receives an output destination instruction indicating that one display device is connected to the receiver 100, from the output determination module 107, the GUI generating module 105 generates a GUI of a screen comprising motion pictures and operation images based on the GUI data comprised in the data-broadcasting data. On the other hand, when the GUI generating module 105 receives an output destination instruction indicating that a screen of operation images and a screen of motion pictures are outputted to different display devices respectively and a notification about the screen size and resolution of the display device to which the screen of operation images is outputted, from the output determination module 107, the GUI generating module 105 generates a GUI of a screen corresponding to the screen size and resolution of the display device to which the screen of operation images is outputted, based on the GUI data comprised in the data-broadcasting data. Then, the GUI generating module 105 outputs the generated GUI of the screen to the display processing module 110.

The display device detection module 106 detects whether there is a display device connected to each of the video output terminals 111 and 112 or not. When there is a display device connected to the video output terminal 111 or 112, the display device detection module 106 receives display device information such as the screen size, resolution, maker, product name of the display device connected to the video output terminal, through the video output terminal. Then, the display device detection module 106 outputs the information as to whether there is a display device connected to each of the video output terminals 111 and 112 or not, and the display device information of the display device connected to each of the video output terminals, to the output determination module 107.

The output determination module 107 has a function of determining respective destinations of outputting of the screen of operation images and the screen of motion pictures based on the display device information, etc. inputted from the display device detection module 106, and informing the display processing module 110 of the determined output destinations.

When the display device information inputted from the display device detection module 106 indicates that display devices are connected to both the video output terminals 111 and 112, the output determination module 107 instructs the display processing module 110 to output the screen of motion pictures and the screen of operation images to the different display devices respectively.

When the display device information inputted from the display device detection module 106 indicates that only one display device is connected to either of the video output terminals 111 and 112, the output determination module 107 instructs the display processing module 110 to output a screen comprising motion pictures and operation images to the connected display device.

The output determination module 107 can generate/register a display device database 108 of display devices connected to the receiver 100 based on the display device information inputted from the display device detection module 106. For example, the display device database 108 is a database in which the screen size, maker name, etc. of each display device which has been ever connected to the receiver 100 are associated with the product name of the display device.

Which display device is used as a main display device can be registered in the database. Incidentally, the main display device means a display device set as a destination of outputting of the screen of motion pictures when display devices are connected to both the video output terminals 111 and 112.

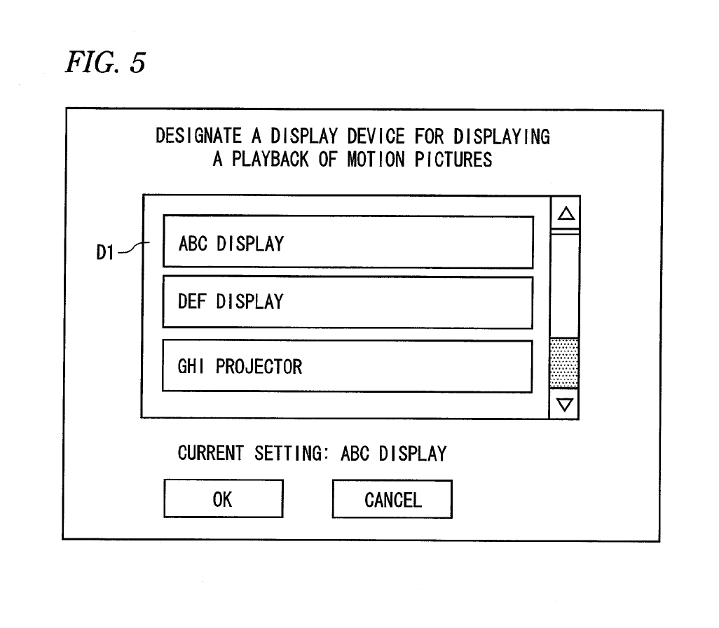

For registration of the main display device, the receiver 100 outputs a setting screen which is as shown in FIG. 5 and will be described later, so that the main display device can be set/registered in accordance with user's command entry for the setting screen. On this occasion, the output determination module 107 sets a main processing device based on a command entry signal which is inputted from the command entry processing module 109 for designating the main processing device. When the display device database 108 and the display device information inputted from the display device detection module 106 indicate that display devices are connected to both the video output terminals 111 and 112 and that one of the display devices is the main display device, the output determination module 107 can instruct the display processing module 110 to output motion pictures to the video output terminal to which the main display device is connected. Incidentally, the setting screen for setting the main display device will be described later with reference to FIG. 5.

When display devices are connected to both the video output terminals 111 and 112, the output determination module 107 determines that a screen of motion pictures should be outputted to a large screen size display device which is one of the display devices connected to the video output terminals 111 and 112 while a screen of operation images is outputted to a small screen size display device which is the other display device, based on screen size information comprised in the display device information inputted from the display device detection module 106.

Then, the output determination module 107 outputs an output designation instruction for designating each determined output designation and a notification indicating the screen size and resolution of each display device to the display processing module 110 and the GUI generating module 105.

The command entry processing module 109 processes a user's command entry signal. For example, the command entry processing module 109 processes a command entry signal for requesting a screen change, command entry signal for requesting termination of the receiver 100, command entry signal for selecting the main display device (which will be described later), etc. inputted from a pointing device, a remote controller, etc. Then, the command entry processing module 109 outputs a notification based on each of these signals to the output determination module 107.

The display processing module 110 converts an operation screen GUI inputted from the GUI generating module 105 and motion picture data inputted from the decoding module 104 into video signals and outputs the video signals to the video output terminals 111 and 112. On this occasion, the display processing module 110 outputs a screen of operation images and a screen of motion pictures converted into video signals respectively to the video output terminals based on the output designation instruction given from the output determination module 107, with resolutions based on the notification about resolution inputted from the output determination module 107.

That is, when the output determination module 107 makes an output designation instruction to output operation images and motion pictures to the different video output terminals respectively, the display processing module 110 outputs the operation images and the motion pictures converted into video signals respectively to the different video output terminals respectively indicated by the output destination instruction. When the display processing module 110 receives an output designation instruction to output operation images and motion pictures to one and the same video output terminal from the output determination module 107, the display processing module 110 outputs the operation images and the motion pictures converted into video signals respectively to one and the same video output terminal.

Each of the video output terminals 111 and 112 is a terminal which can be connected to a display device so that a video signal inputted from the display processing module 110 is outputted to the connected display device. The video output terminals 111 and 112 can receive display device information of the display devices from the display devices connected to these terminals, so that the received display device information is received by the display device detection module 106.

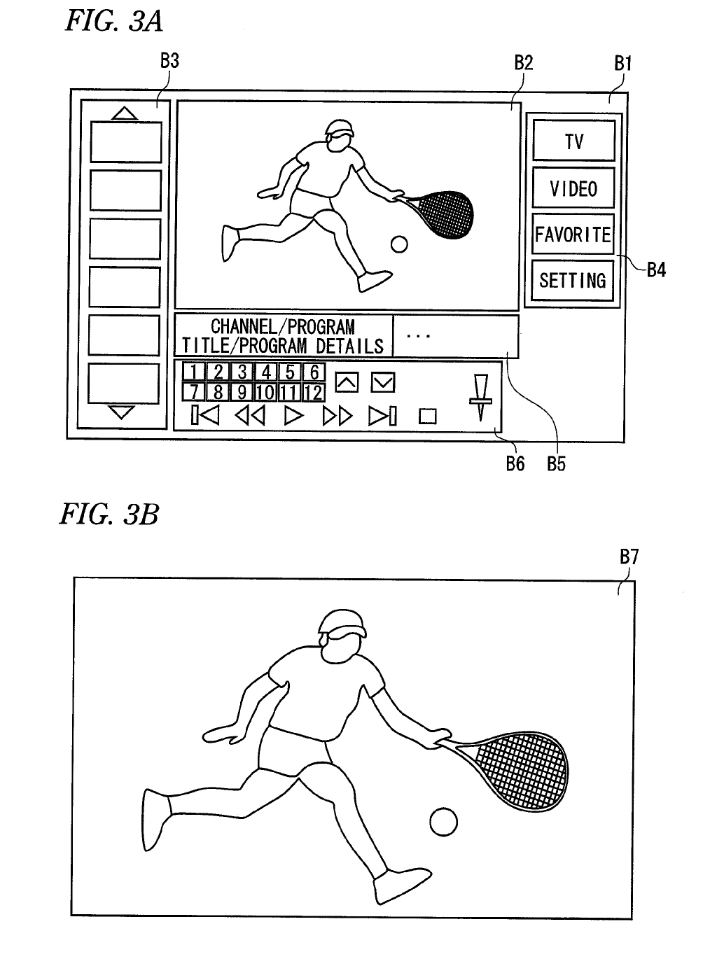

A screen outputted by the receiver 100 when a single display device is connected to the receiver 100 will be described next with reference to FIGS. 3A and 3B.

FIG. 3A shows an example of a screen which comprises motion pictures and operation images and which is outputted to one display device when the display device is connected to either of the video output terminals 111 and 112 of the receiver 100.

A motion picture display region B2, a data-broadcasting image display region B3, a contents detail display region B4, an operation image display region B5 and an operation image display region B6 are displayed on a screen B1 shown in FIG. 3A. The motion picture display region B2 is a region for displaying motion pictures based on motion picture data comprised in video contents data.

The data-broadcasting image display region B3 is a region for displaying images based on data-broadcasting data comprised in video contents data. For example, images indicating contents or Internet sites related to the motion pictures displayed in the motion picture display region B2 or images indicating information of popular programs or the like are displayed in the data-broadcasting image display region B3.

Incidentally, the images displayed in the data-broadcasting image display region B3 comprise operation images each of which is provided for allowing a user to enter selection command on the image. For example, when the receiver 100 receives a selection command on an image which is displayed in the region B3 and which indicates contents related to motion pictures, detailed information of contents corresponding to the image on which the selection command is entered, or motion pictures, etc. of the contents may be displayed in the motion picture display region B2.

The contents detail display region B4 is a region for displaying the details of motion pictures displayed in the motion picture display region B2. For example, the broadcast channel, program title, cast and program detail description, etc. of the motion pictures are displayed based on program information comprised in data-broadcasting data.

The operation image display region B5 is a region for displaying operation images for command entry for video contents data. For example, operation images for command entry for obtaining movie contents from an IPTV server, for displaying a list of favorite contents registered in advance by the user, etc. are displayed in the region B5.

The operation image display region B6 is a region for displaying operation images for command entry for motion pictures displayed in the motion picture display region B2. For example, operation images for the motion pictures, that is, operation images for command entry for selecting motion pictures to be displayed in the motion picture display region B2, for command entry for changing an output volume, and for command entry for playing/stopping the motion pictures are displayed in the region B6.

The regions B2 and B3 displayed on the screen B1 are arranged in positions based on GUI data comprised in data-broadcasting data. The images displayed in the data-broadcasting image display region B3 and the contents detail display region B4 are images based on image data etc. comprised in data-broadcasting data. On the other hand, the images displayed in the operation image display regions B5 and B6 may be images based on image data comprised in data-broadcasting data or may be based on images which are stored in the receiver 100 in advance.

FIG. 3B will be described next. FIG. 3B shows an example of a screen outputted by the receiver 100 when command entry for requesting a screen change is given to display a screen of the enlarged motion picture display region B2 while the receiver 100 outputs the screen B1. In FIG. 3B, the motion picture display region B2 displayed on the screen B1 is enlarged so that the enlarged motion picture display region B2 is displayed in a screen B7 which is displayed over the whole display screen of the display device.

Incidentally, the output screen B7 does not need to be a region in which the motion picture display region B2 is displayed on the whole display screen. That is, the output screen B7 may be displayed in a region larger than the region B2. When the receiver 100 receives command entry for requesting a screen change to display a screen of arrangement of operation images and motion pictures, that is, to display the screen B1 while the screen B7 is being displayed, the receiver 100 outputs the screen B1.

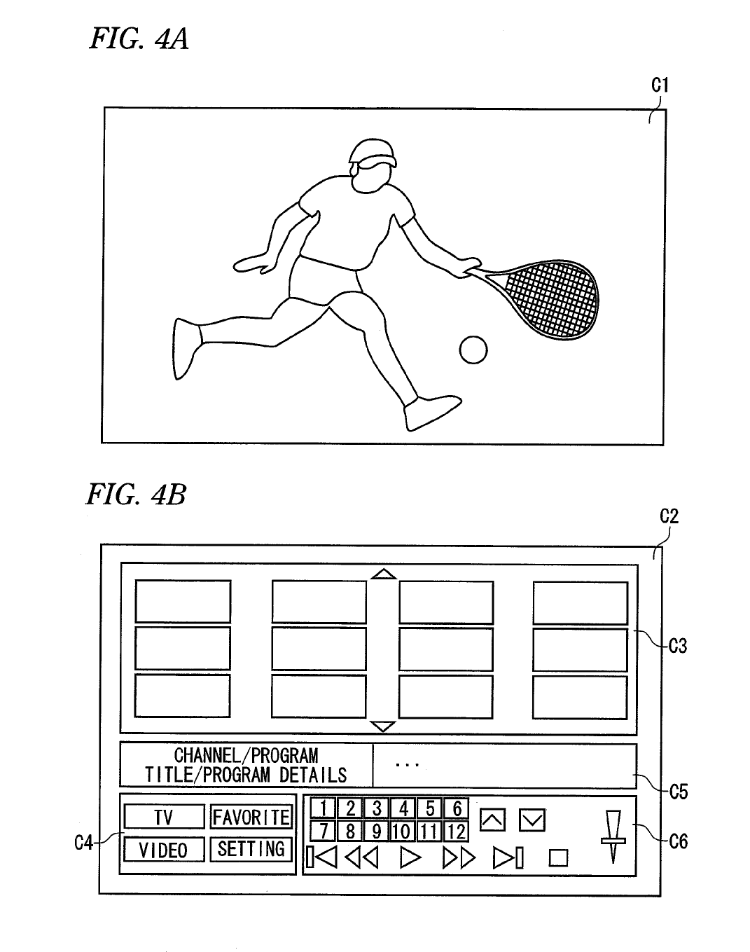

Output screens when the receiver 100 outputs a screen of motion pictures and a screen of operation images to different display devices respectively will be described next with reference to FIGS. 4A and 4B.

FIG. 4A shows an example of the screen of motion pictures when display devices are connected to both the video output terminals 111 and 112 of the receiver 100 so that the screen of motion pictures and the screen of operation images are outputted to the different display devices respectively. Motion pictures based on motion picture data decoded by the decoding module 104 are displayed on a screen C1 shown in FIG. 4A. Although FIG. 4A shows the case where motion pictures are displayed on the whole of the screen C1, motion pictures does not need to be displayed on the whole of the screen C1. For example, motion pictures may be displayed in a part of the screen C1 which has a predetermined size.

On the other hand, FIG. 4B shows an example of the screen of operation images when the receiver 100 outputs the screen of motion pictures and the screen of operation images to different display devices respectively.

A data-broadcasting image display region C3, a contents detail display region C4, an operation image display region C5 and an operation image display region C6 are arranged adjacently on a screen C2 shown in FIG. 4B. Images displayed in the regions C3 to C6 correspond to those displayed in the regions B3 to B6 shown in FIG. 3A. That is, images displayed in the region C3 correspond to those displayed in the region B3, images displayed in the region C4 correspond to those displayed in the region B4, images displayed in the region C5 correspond to those displayed in the region B5, and images displayed in the region C6 correspond to those displayed in the region B6. The regions C3 to C6 displayed on the screen C2 are however displayed in a display format different from that of the regions B3 to B6 displayed on the screen B1. Incidentally, each of images displayed on the screen C2 is an image which is generated by the GUI generating module 105 so that the image has resolution corresponding to the screen resolution, etc. of the display device.

Because the data-broadcasting image display region C3 is displayed in a display format different from that of the data-broadcasting image display region B3, a greater deal of information than that in the region B3 can be displayed in the data-broadcasting image display region C3. Although the display format of the regions C3 to C6 is not limited to the display format shown in FIG. 4B, it is desirable that the regions C3 to C6 are provided so adjacently that the regions C3 to C6 are widened.

The size of the data-broadcasting image display region C3 or the contents detail display region C4 may be changed according to the screen size of the display device. When the size of the region C3 or C4 is changed thus according to the screen size of the display device, a great deal of information can be displayed in the region C3 or C4 when the screen C2 is displayed on the display device large in screen size. In this manner, the screen of motion pictures and the screen of operation images are outputted to different display devices respectively so that the operation images can be displayed while the motion pictures are displayed widely on the screen.

A setting screen outputted by the receiver 100 so that a main display device can be set will be described next with reference to FIG. 5.

The name of a main display device currently set is displayed on the setting screen shown in FIG. 5 in order to urge the user to set the main display device. The names of display devices which have been ever connected to the receiver 100 until now are displayed in a region D1. Incidentally, the screen size, manufacture name, etc. of each display device may be displayed in the region D1 so as to be associated with the product name of the display device.

When the command entry processing module 109 receives a signal of command entry for selecting any one of the display devices displayed in the region D1 on the setting screen, the output determination module 107 registers the selected display device as a main display device in the display device database 108.

The output determination module 107 determines a screen output destination by referring to the display device database 108 in which display devices are registered. Accordingly, when display devices are connected to both the video output terminals 111 and 112 after registration of the main display device and one of the display devices is the main display device registered in the display device database 108, the screen of motion pictures is outputted to the main display device while the screen of operation images is outputted to the other display device than the main display device.

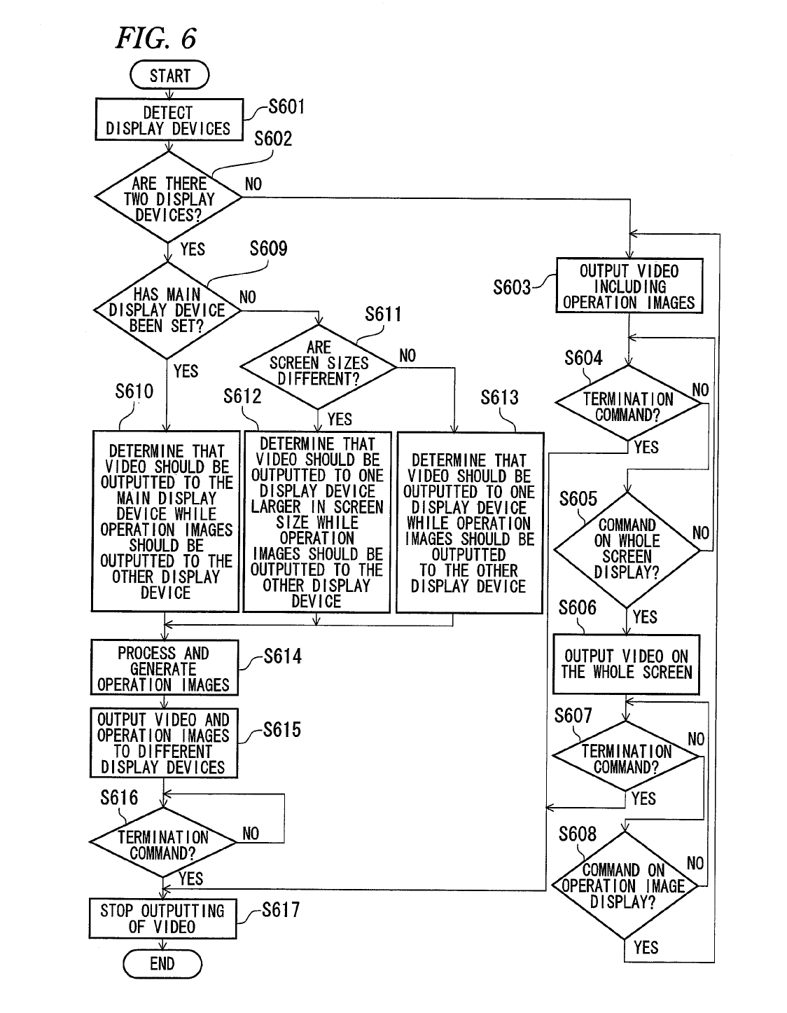

The processing operation of the receiver 100 according to this embodiment will be described next with reference to FIG. 6. FIG. 6 is an exemplary flow chart showing an operation when the receiver 100 outputs video signals to display devices.

First, the display device detection module 106 detects whether there is a display device connected to each of the video output terminals 111 and 112 or not, and when there is a display device connected to each of the video output terminals, the display device detection module 106 receives display device information such as the screen size, maker name, product name, etc. of the display device connected to each of the video output terminals (S601).

When a display device is connected to only one of the video output terminals 111 and 112 (No in S602), the output determination module 107 determines that a screen comprising motion pictures and operation images should be outputted to the display device, and the display processing module 110 outputs a video signal of the screen comprising motion pictures and operation images, that is, the screen shown in FIG. 3A to the video output terminal to which the display device is connected (S603). When the command entry processing module 109 receives command entry for requesting termination of the receiver 100 on this occasion (Yes in S604), the receiver 100 stops outputting of the video signal (S617).

On the other hand, when the command entry processing module 109 does not receive the termination command entry (No in S604), the output determination module 107 then determines whether an enlarged screen display instruction is inputted from the command entry processing module 109 to display a screen having the enlarged motion picture display region B2 or not (S605). When the enlarged screen display instruction is not inputted (No in S605), the receiver 100 performs processing in S604 again.

On the other hand, when the output determination module 107 receives an enlarged screen display instruction, the output determination module 107 outputs an instruction to the display processing module 110 to output a display screen of enlarged motion pictures, and the display processing module 110 outputs a video signal of the display screen of enlarged motion pictures, that is, the screen shown in FIG. 3B to the video output terminal to which the display device is connected, based on the instruction (S606).

When the command entry processing module 109 receives command entry for requesting termination of the receiver 100 (Yes in S607), the output determination module 107 performs processing in S617. On the other hand, when the command entry processing module 109 does not receive the termination command entry (No in S607), the output determination module 107 then determines whether the command entry processing module 109 receives command entry for displaying a screen of arrangement of operation images and motion pictures or not (S608). When the command entry processing module 109 does not receive the command entry (No in S608), the output determination module 107 performs processing in S607 again. When the command entry processing module 109 receives the command entry (Yes in S608), the output determination module 107 performs processing in S603 again.

Processing in and after S609 will be described next. When the display device detection module 106 detects in S602 that display devices are connected to both the video output terminals 111 and 112, the output determination module 107 then determines whether the main display device has been registered in the display device database 108 or not (S609).

When the main display device has been registered (Yes in S609), the output determination module 107 determines that a screen of motion pictures should be outputted to the main display device and a screen of operation images should be outputted to the other display device than the main display device (S610), and outputs an output designation instruction and a screen size notification to the GUI generating module 105 and the display processing module 110.

On the other hand, when the main display device has not been registered (No in S609), the output determination module 107 then determines whether the display devices connected to the video output terminals 111 and 112 are different in screen size or not, based on screen size information comprised in display device information inputted from the display device detection module 106 (S611). When the display devices are different in screen size (Yes in S611), the output determination module 107 determines that a screen of motion pictures should be outputted to one video output terminal to which the display device larger in screen size is connected while a screen of operation images should be outputted to the other video output terminal to which the display device smaller in screen size is connected (S612), and outputs an output destination instruction and a screen size notification based on the determination to the GUI generating module 105 and the display processing module 110.

On the other hand, when the display devices are equal in screen size (No in S611), the output determination module 107 determines that a screen of motion pictures should be outputted to one of the display devices connected to the video output terminals 111 and 112 while a screen of operation images should be outputted to the other display device. Incidentally, as for processing in S613, for example, the output determination module 107 may determine that a screen of motion pictures should be outputted to the display device connected to the video output terminal 111 while a screen of operation images should be outputted to the display device connected to the video output terminal 112.

Then, the GUI generating module 105 generates a screen corresponding to the screen size of the display device, to which the screen of operation images should be outputted, based on the output designation instruction and the screen size notification inputted from the output determination module 107.

When the command entry processing module 109 receives command entry for requesting termination of the receiver 100 (Yes in S616), the receiver 100 stops outputting of the video signal (S617) and terminates this processing.

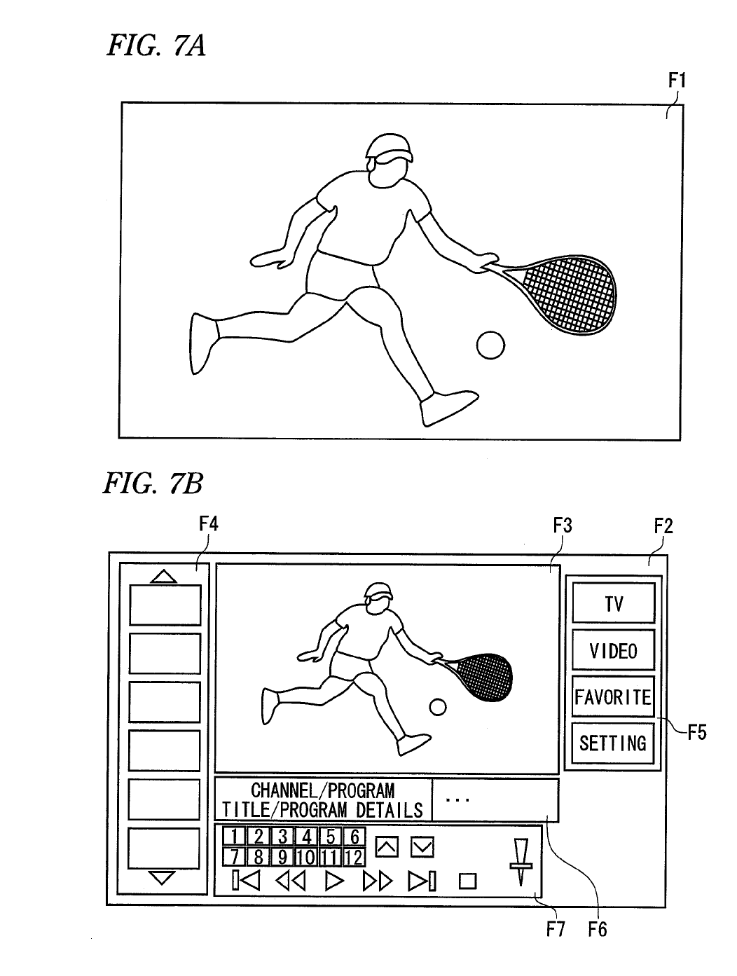

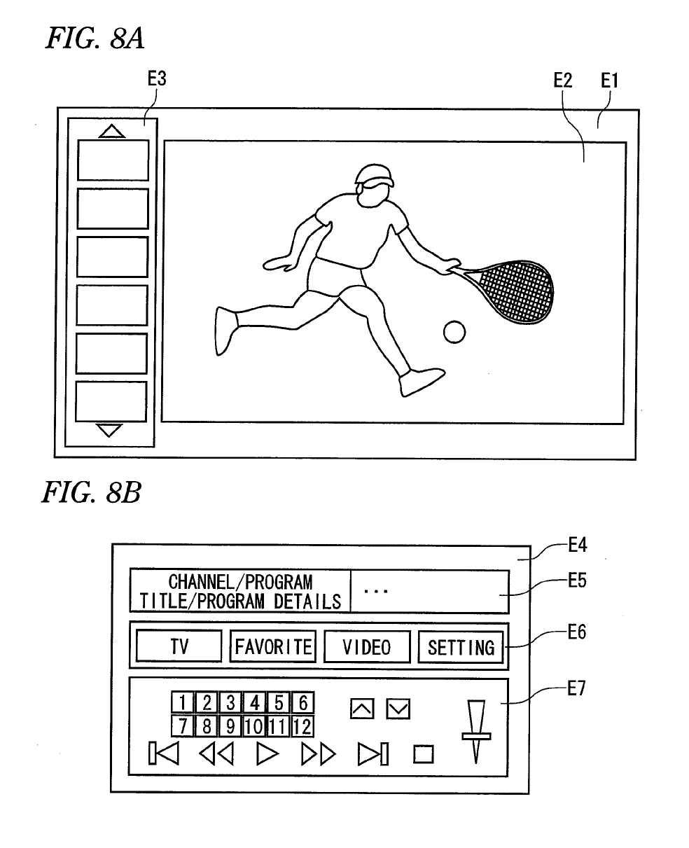

Other examples of the display format of screens outputted by the receiver 100 will be described next with reference to FIGS. 7A and 7B and FIGS. 8A and 8B.

FIGS. 7A and 7B are views showing examples of screens outputted by the receiver 100. Description has been made with reference to FIGS. 4A and 4B in the case where when display devices are connected to both the video output terminals 111 and 112, the receiver 100 outputs a screen of motion pictures (e.g. FIG. 4A) to one display device and a screen of operation images (e.g. FIG. 4B) to the other display device. On the contrary, as for screens shown in FIGS. 7A and 7B, when display devices are connected to both the video output terminals 111 and 112 of the receiver 100, a screen of motion pictures is outputted to one display device and a screen of motion pictures and operation images is outputted to the other display device.

FIG. 7A shows a screen of motion pictures outputted by the receiver 100. In FIG. 7A, a screen F1 is a screen on the whole of which motion pictures are displayed. Incidentally, motion pictures do not need to be displayed on the whole of the screen F1. For example, motion pictures may be displayed on a part of the screen F1. FIG. 7B shows an example of a screen which comprises motion pictures and operation images and which is outputted by the receiver 100. A motion picture display region F3, a data-broadcasting image display region F4, a contents detail display region F5, an operation image display region F6 and an operation image display region F7 are displayed on a screen F2. These regions F3 to F7 are regions having functions corresponding to the regions B2 to B6 shown in FIG. 3A. That is, F3 corresponds to B2, F4 corresponds to B3, F5 corresponds to B4, F6 corresponds to B5, and F7 corresponds to B6.

When two display devices are connected in this manner, the receiver 100 can output a screen comprising motion pictures and operation images as shown in FIG. 7B to one display device. Some of the operation images such as an operation image displayed in the data-broadcasting image display region F4 may be configured so that detailed information and video of contents corresponding to an image are displayed in the motion picture display region F3 when command entry for selecting the image is given.

Therefore, one and the same screen in which the motion picture display region F3 and the data-broadcasting image display region F4 are arranged is outputted by the receiver 100 so that the user can easily confirm detailed information and video of contents corresponding to the image selected by the user when the user enters command for selecting the image displayed in the data-broadcasting image display region F4.

Output screens in a further embodiment will be described with reference to FIGS. 8A and 8B. FIGS. 8A and 8B are views showing other examples of screens outputted by the receiver 100.

When display devices are connected to both the video output terminals 111 and 112 of the receiver 100 according to the embodiment, the receiver 100 outputs a screen comprising motion pictures and images based on data-broadcasting data to one display device and a screen of operation images to the other display device.

FIGS. 8A and 8B will be described next. FIG. 8A shows a screen which comprises motion pictures and images based on data-broadcasting data and which is outputted by the receiver 100. In FIG. 8A, a motion picture display region E2 and a data-broadcasting image display region E3 are displayed on a screen E1. E2 has a function corresponding to B2 in FIG. 3A, and E3 has a function corresponding to B3 in FIG. 3A.

FIG. 8B shows an example of a screen of operation images outputted by the receiver 100. In FIG. 8B, an operation image display region E5, a contents detail display region E6 and an operation image display region E7 are displayed on a screen E4. These regions E5 to E7 are regions having functions corresponding to the regions B4 to B6 shown in FIG. 3A. That is, E5 corresponds to B5, E6 corresponds to B4, and E7 corresponds to B6.

When two display devices are connected, the receiver 100 can output a screen comprising motion pictures and operation images as shown in FIG. 8A to one display device. Thus, the receiver 100 can display motion pictures in a wide region and display information of contents, Internet sites, etc. concerned with the motion pictures on the same screen as the motion pictures, so that the user can easily confirm the motion pictures and contents, etc. concerned with the motion pictures.

According to the aforementioned embodiment, the receiver 100 can output screens of different display formats in accordance with the number of display devices which are connected to the receiver 100 and which can output video, so that suitable video screens can be provided to the user. Moreover, when the number of display devices connected to the receiver 100 is 2, the receiver 100 can output a screen of motion pictures to the main display device registered in the display device database 108. Accordingly, when the receiver 100 receives user's command entry for registration of a main display device, the screen of motion pictures can be outputted to the display device desired by the user.

In addition, when the display devices connected to the receiver 100 are different in screen size, the receiver 100 can output a screen of motion pictures to a display device large in screen size. Consequently, the receiver 100 can display motion pictures on a larger screen.

### Second Embodiment

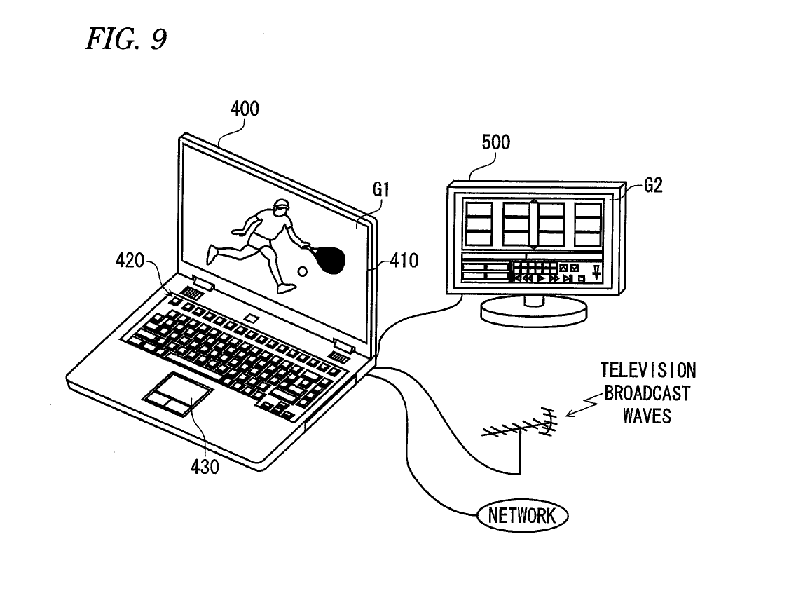

The available form of an electronic device according to a second embodiment will be described below with reference to FIG. 9. Although the electronic device according to the first embodiment has been put into practice as a receiver 100 using display devices connected to the receiver 100, for example, the electronic device according to the second embodiment is put into practice as a computer 400 which comprises a display module 410 and which can be connected to an external display device 500.

The computer 400 can receive video contents data comprising video data and data-broadcasting data such as digital broadcast contents, IPTV contents, etc. and output screens based on the video contents data to the display module 410 and the display device 500.

In the computer 400 according to the second embodiment, when these screens are outputted to the display devices, the display format of the screen to be outputted can be switched in accordance with whether the external display device is connected to the computer 400 or not. Incidentally, the system configuration and processing procedure of the computer 400, the screens outputted by the computer 400, etc. are the same as those in the first embodiment, so that description thereof will be omitted.

While certain embodiments have been described, these embodiments have been presented by way of example only, and are not intended to limit the scope of the invention. Indeed, the novel device described herein may be embodied in a variety of other forms; furthermore, various omissions, substitutions and changes in the form of the device described herein may be made without departing from the sprit of the invention. The accompanying claims and their equivalents are intended to cover such forms or modifications as would fall within the scope and sprit of the invention.

What is claimed is:

1. An electronic device comprising:
a video receiving module configured to receive video data comprising motion picture data;
a user interface module configured to generate operation image data for command entry; and
a video output module configured to output video or image data to a first display device and a second display device, wherein the video output module is configured to
output the motion picture data to the first display device and to output the operation image data to the second display device if both the first display device and the second display device are configured to display video or image received from the video output module, and
output a combined video/image data comprising the motion picture data and the operation image data to one of the first and second display devices if one of the first display device and second display device is configured to display video or image received from the video output module.

2. The device of claim 1, wherein
the video data comprises data-broadcasting data, and
the video output module is configured to output the motion picture data to the first display device and to output the operation image data based on the data-broadcasting data to the second display device when both the first and the second display devices are configured to display video or image received from the video output module.

3. The device of claim 1, wherein a first screen generated by the operation image data is different from a second screen generated by the combined video/image data.

4. The device of claim 1, wherein the video output module is configured to output the operation image data of the first screen with a display format corresponding to a screen size of the second display device if both the first display device and the second display device are configured to display video or image received from the video output module.

5. The device of claim 1, wherein the video output module is configured to output the operation image data of the first screen with a resolution corresponding to the resolution of the second display device if both the first display device and the second display device are configured to display video or image received from the video output module.

6. The device of claim 1, wherein the video output module is configured to output the motion picture data with a resolution corresponding to the resolution of the first display device if both the first display device and the second display device are configured to display video or image received from the video output module.

7. The device of claim 1, wherein a screen size of the first display device is larger than a screen size of the second display device.

8. The device of claim 1, wherein the first screen comprises a screen for displaying motion pictures generated by the motion picture data.

9. The device of claim 1, wherein
the video data comprises data-broadcasting data, and
the video output module is configured to output data for displaying a screen comprising motion pictures from the motion picture data and operation images from the operation image data to the first display device if both the first display device and the second display device are configured to display video or image received from the video output modules, wherein the operation image data is based on the data-broadcasting data.

10. The device of claim 1, wherein a second screen from the combined video/image data and the motion pictures from the motion picture data are switchably displayed on the first or second display devices.

11. The device of claim 1, further comprising:
a registration module configured to register the first display device,
wherein the video output module is configured to output the motion picture data to the first display device registered in the registration module.
